(19) United States
(12) Patent Application Publication
(10) Pub. No.: US 2007/0066919 A1
(43) Pub. Date: Mar. 22, 2007

(54) Massage device and method

(75) Inventor: Jean-Louis Gueret, Paris (FR)

Correspondence Address: OLIFF & BERRIDGE, PLC, P.O. BOX 19928, ALEXANDRIA, VA, 22320, US

(73) Assignee: L'Oreal, Paris (FR)

(21) Appl. No.: 11/521,344

(22) Filed: Sep. 15, 2006

Related U.S. Application Data
(60) Provisional application No. 60/723,450, filed on Oct. 5, 2005.

(30) Foreign Application Priority Data
Sep. 16, 2005 (FR) 05 52800

(51) Int. Cl. A61H 7/00

(52) U.S. Cl. 601/138; 601/137; 601/135

(57) ABSTRACT

A massage device may include: an elongate handle including a handle-forming body, and a frame including an orientation that is substantially constant relative to the body; and an elastically deformable massage member that defines a massage surface configured to come into contact with a region to be treated, and a side opposite from the massage surface. The massage member may include a periphery at which the massage member is secured to the frame. The massage member may be configured to be deformed by a user by exerting pressure on the massage member on the side opposite from the massage surface. The massage surface may be outwardly convex and solid.

This non provisional application claims the benefit of French Application No. 05 52800 filed on Sep. 16, 2005 and U.S. Provisional Application No. 60/723,450 filed on Oct. 5, 2005, the entire disclosures of which are incorporated herein by reference.

### BACKGROUND

The present invention relates to massage devices, for example, for massaging the face.

Static massage devices disposed at the end of a handle are known. U.S. Pat. Nos. 5,673,455, 5,020,182, 4,508,108, and 4,463,485 disclose devices of that type.

Dynamic massage devices comprising balls or rollers are also known. European Patent EP 092 449 and U.S. Pat. No. 4,427,001 disclose devices of that type.

In addition, European patent EP 1 059 047 describes an applicator including a hinged head.

### SUMMARY

In exemplary embodiments, the invention seeks to provide a massage device that is comfortable to use, that is of simple construction, that is hygienic, and/or that makes it possible, for example, to treat relatively small regions, for example, belonging to the face.

Exemplary embodiments of the invention may thus provide a massage device comprising: an elongate handle comprising a handle-forming body, and a frame including an orientation that is substantially constant relative to the body; and an elastically deformable massage member that defines a massage surface configured to come into contact with a region to be treated, the massage member being secured at a periphery thereof to the frame, and being configured to be deformed by the user by exerting pressure on the massage member on a side opposite from the massage surface. The massage surface may be outwardly convex, for example.

In exemplary embodiments, the massage action may be performed with or without applying a massage composition.

The frame may impart a relatively great flexibility to the massage member, and also may enable the user to exert pressure on the massage member, if so desired, on the side opposite from the massage surface. The user may thus perform a massage that is energetic to a greater or lesser extent, depending on the pressure exerted. The massage member may also be made in such a manner as to enable the user to stretch the massage member by exerting pressure through the frame, for example, to include a smaller area of contact surface with the region to be treated.

In non-limiting exemplary embodiments, the massage member may be configured such that when the massage member is deformed by the user, the massage member becomes stiffer.

For example, the frame may advantageously include a closed outline and a circular shape. Such a shape may make it easier to secure a massage member of convex shape, for example, including a massage surface that may be outwardly convex.

The handle may be non-deformable. The handle may be other than a clamp. The device may not include a pivotal connection between the frame and the body of the handle.

The frame and the body may each be a single part.

In non-limiting exemplary embodiments, the frame may be bent and the frame may extend substantially along a plane forming an angle relative to a longitudinal axis of the body of the handle. The angle may be strictly less than 90°, or better an angle lying in a range of 1° to 80°, better still in a range of 5° to 15°.

The massage surface may advantageously be situated on a the longitudinal-axis side of the body of the sleeve, thereby making it more ergonomic to treat regions of the face.

The massage member may comprise a membrane, which may be elastic, for example, being of an elastomer material, for example. This may make it easier to wash the massage member. The elastomer material may optionally be a cellular material.

For example, and particularly when the massage member is a membrane, the massage member may be, at least in part, or even entirely, of silicone, nitrile rubber, butyl, latex, vulcanizable or thermoplastic elastomer, styrene-isoprene-styrene (SIS), styrene-butadiene-styrene (SBS), styrene-ethylene-butylene-styrene (SEBS), polyester elastomer, for example, Hytrel®, polyamide elastomer, Pebax®, ethylene-propylene-terpolymer rubber (EPDM) elastomer, Santoprene®, polyvinyl chloride (PVC) or ethyl vinyl acetate (EVA) elastomer, this list not being limiting.

The membrane may be solid, that is, deprived of through openings. The membrane may include portions in relief other than micro-portions in relief resulting from weaving a fabric, for example.

The side of the massage member opposite from the massage surface may be concave.

On a massage-surface side, the membrane may be provided with a structure fitted thereto, for example, a net, a foam, a textile or a non-woven fabric.

The membrane may include a general shape that projects beyond the frame.

For example, the membrane may include a generally convex shape, with or without undulations.

The massage member may include portions in relief that may be distributed thereover, optionally in an even manner. The portions in relief may include an abrasive character, where appropriate or desired.

The massage member may include spikes.

The massage member may be secured to the handle by being molded thereover. The massage member may also be bonded or heat-sealed on the handle.

In exemplary embodiments, the massage member may be interchangeable, for example, being fastened by snap-fastening on the handle.

The massage member may include a finger on the side opposite from the massage surface, which may enable the user to deform the massage surface. The finger may be centered or off-center. For example, the user may press on the finger along the axis so as to stretch the massage member, and/or tilt the finger so as to modify the general shape of the massage member.

In exemplary embodiments, the device may include a rigid or semi-rigid intermediate part on the side opposite from the massage surface, which may enable the user to deform the massage member by pressing against the intermediate part. The intermediate part may be configured to be capable of deforming substantially when the user presses thereagainst.

For example, the intermediate part may be separate from the handle and may be held on the device by being fastened to the massage member, for example, or by being held between the frame and the membrane.

The intermediate part may optionally be perforated.

The intermediate part need not press against the entire face of the membrane, for example, and may include a star shape.

The device may include a second massage member, for example, at another end of the handle. The second massage member may be configured to rotate.

In exemplary embodiments, the body of the handle may not include a reservoir of composition, and the device may not include a vibrator. This may not be the case, however.

Exemplary embodiments of the invention may provide a massage method in which the massage member of a massage device, for example, as defined above, is applied to a region of the body or the face, and in which at least one finger is optionally pressed against the massage member on the side opposite from the massage surface.

### BRIEF DESCRIPTION OF THE DRAWINGS

Various details of the present invention may will be better understood on reading the following detailed description of non-limiting embodiments, and on examining the accompanying drawings, in which:

FIG. 1 is a front view of an exemplary device;

FIG. 2 is a longitudinal cross-sectional view taken along 11-11 of FIG. 1;

FIGS. 3 and 4 are views similar to FIG. 2, illustrating use of the device;

FIG. 5 illustrates how the massage member may be removably fastened on the handle;

FIG. 6 illustrates an exemplary kit comprising a plurality of interchangeable massage members;

FIG. 7 is a diagrammatic view, in fragmentary longitudinal cross-section, illustrating another exemplary device;

FIG. 8 is a view similar to FIG. 7 illustrating another exemplary device;

FIG. 9 illustrates another exemplary massage member;

FIG. 10 illustrates deformation of the massage member of FIG. 9;

FIG. 11 illustrates providing an intermediate part on the side opposite from the massage surface;

FIGS. 12 to 16 illustrate various exemplary portions in relief that are suitable for being formed on the massage member;

FIGS. 17 to 19 illustrate other exemplary massage members; and

FIG. 20 illustrates providing a second massage member on the handle.

### DETAILED DESCRIPTION OF EMBODIMENTS

An exemplary massage device 1, as illustrated in FIGS. 1 to 4, may comprises: a handle 2 including a handle-forming body 11, and being elongate along a longitudinal axis X; and a head formed by a frame 3 supporting a massage member 4 that projects beyond the frame 3.

In exemplary embodiments, the body 11 may be generally flat, being of cross-section that may be not perforated.

The handle 2 may be of a material that is relatively rigid or flexible, and that may optionally flex in use. However, the frame 3 may maintain an orientation that is substantially constant relative to the body 11, given that there is no hinge therebetween.

In exemplary embodiments, the frame 3 may include a closed outline of generally circular shape when observed from the front, extending along a plane P forming an angle a relative to the longitudinal axis X. The angle a may lie in a range of about 1° to about 80°, for example, and may be close to 10°, for example.

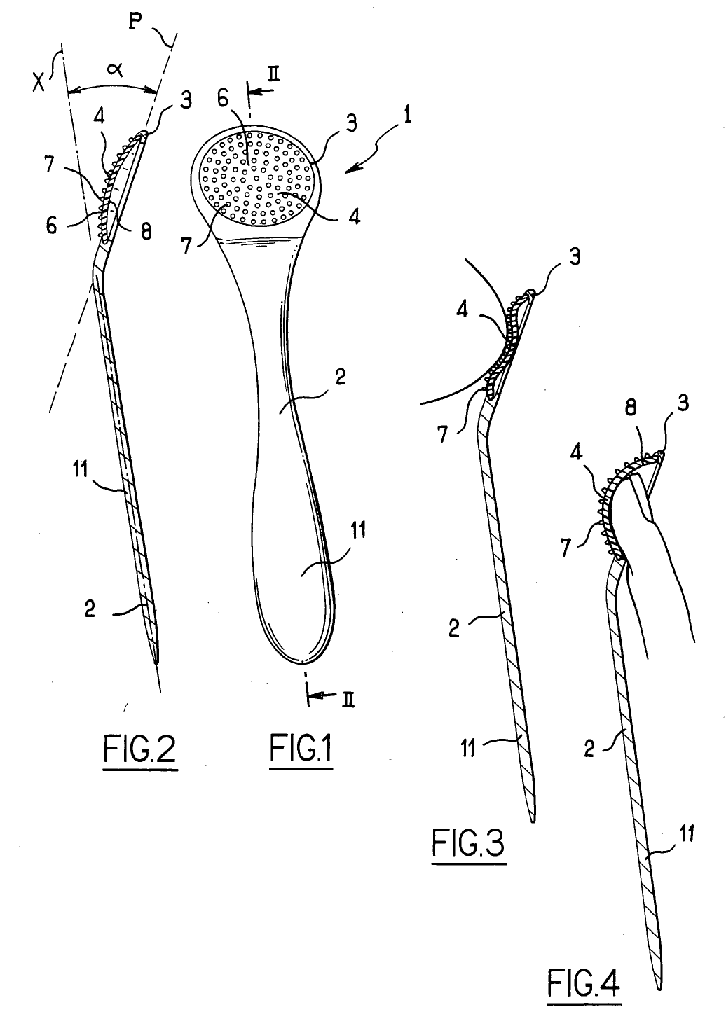

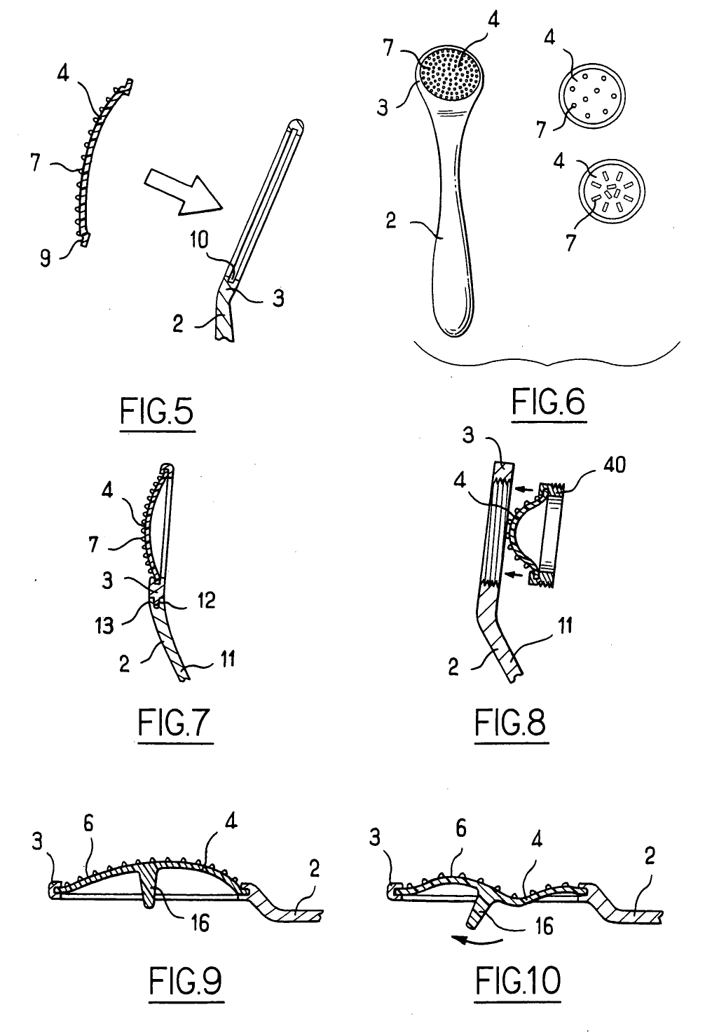

In exemplary embodiments, the massage member 4 may comprise an elastomer membrane that may be secured at a periphery thereof to the frame 3, and that may be of a shape that may be generally convex toward the axis X, as illustrated in FIG. 2.

The membrane 4 may define a generally convex massage surface 6 provided with portions in relief 7, and a hollow surface 8 against which the user may press with a finger, as illustrated in FIG. 4. The membrane 4 may deform elastically so as to match a shape of a region being treated, as illustrated in FIG. 3.

The membrane 4 may be secured in various ways to the handle 2, and the frame 3 may be overmolded onto the membrane, for example, or vice versa. In exemplary embodiments, the membrane 4 may be secured to the frame 3 by heat-sealing or by adhesive, or may be held thereon by a holding part, as described below.

It is also possible for the massage member 4 to be mounted removably, thereby making it possible, for example, for the user to clean the massage member 4 more easily, or to select the massage member 4 as a function of the treatment to be performed.

As illustrated in FIG. 5, the massage member 4 may be configured in such a manner as to be fastened in an interchangeable manner on the handle 2, by snap-fastening on the frame 3, for example. At the periphery, the massage member 4 may include a bead 9 that may be configured to snap-fasten in an annular groove 10 formed on an inside surface of the frame 3.

By including a massage member 4 that may be removably-fastenable, the user may use a single handle 2 and a plurality of massage members 4 including different characteristics, the user being able to select the massage member 4 that may be suitable for a particular region of the body or of the face, and/or that may be suitable for a type of treatment to be performed, for example, stimulating blood circulation, lymphatic drainage, dermabrasion, or applying a composition.

For example, the massage members 4 associated with the handle 2 may include portions in relief 7 that are different.

FIG. 7 illustrates the possibility of the handle 2 including a removable frame 3. The massage member 4 may then be capable of being connected in a non-removable manner to the frame 3.

The user may thus replace a frame 3 provided with a massage member 4 with another frame 3 provided with a different massage member.

For example, the frame 3 may be fastened in a removable manner on the body 11 of the handle by co-operating portions in relief 12 and 13.

As illustrated in FIG. 8, it is also possible to make the massage member 4 with a fastener portion 40, such as a relatively rigid ring, for example, that is configured to be fastened in a removable manner on the frame 3, for example, by screw-fastening.

FIGS. 9 and 10 illustrate an exemplary embodiment in which the massage member 4 includes, on the side opposite from the massage surface 6, a finger 16 that may be moved by the user, thereby enabling the user to deform the massage surface.

By moving the finger 16 with the thumb or the index finger, for example, the user may thus impart to the massage surface 6, a particular shape that may be adapted to the region to be treated.

The user may also press on the finger 16 so as to exert pressure via the massage member 4 on the region to be treated.

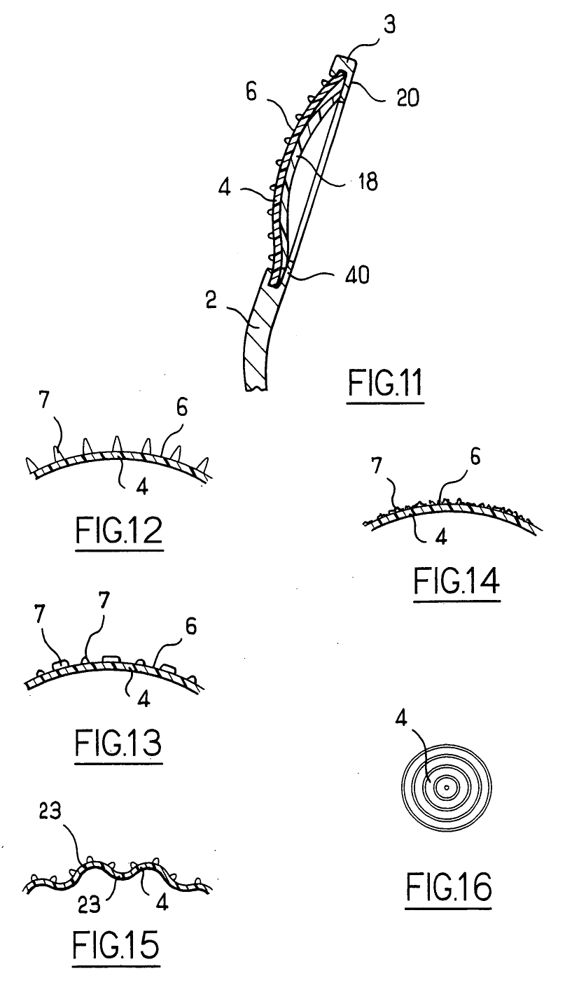

As illustrated in FIG. 11, the device 1 may include an intermediate part 18 on the side opposite from the massage surface 6, and on which the user may press so as to deform the massage member 4. For example, the intermediate part 18 may be held between the massage member 4 and a rib 40 of the frame 3. An inside edge of the rib 40 may define an opening of the frame 3.

The intermediate part 18 may include very different shapes, and, for example, need not cover the entire facing face of the massage member.

The intermediate part 18 may include a star shape, for example.

Various portions in relief 7 may be formed on the massage surface 6, depending on a desired result, and the portions in relief may be in the shape of hemi-spheres, as illustrated in FIG. 2, or in the shape of spikes, as illustrated in FIG. 11.

The massage surface 6 may include portions in relief of various shapes, as illustrated in FIG. 13.

The portions in relief 7 may be distributed evenly over the massage surface 6, or may be distributed unevenly, as illustrated in FIG. 14. Where appropriate or desired, the massage member may include undulations 23, as illustrated in FIG. 15.

The portions in relief 7 may extend in various directions when the massage member is at rest.

The portions in relief 7 may include various configurations when the massage member is observed from above. For example, the portions in relief 7 may optionally be disposed in a concentric manner, as illustrated in FIG. 16.

The portions in relief 7 may be made integrally, i.e., monolithically, with the massage member 4 by injection-molding, for example, when the massage member includes an elastomer membrane.

The massage member 4 may include an elastically deformable cellular membrane that may be constituted by a foam, as illustrated in FIG. 17.

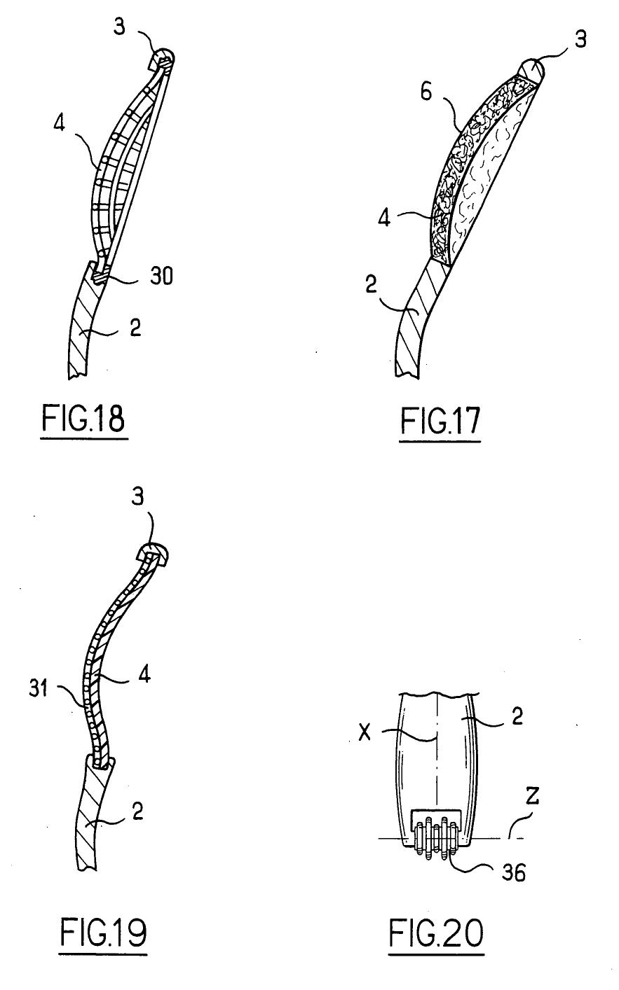

The massage member 4 may also include a mesh, as illustrated in FIG. 18.

FIG. 18 illustrates the possibility of fastening the massage member 4 on the frame 3 by a holding part 30 that may be independent of the massage member 4 and that may be fastened on the frame 3 by snap-fastening or by screw-fastening, for example, to hold the massage member 4 thereagainst.

FIG. 19 illustrates the possibility of making the massage member 4 with a flexible membrane that may be lined on the massage-surface side with a fitted structure 31, such as a net or a foam.

In any of the above-described embodiments, the handle 2 may be provided with a second massage member 36, at an end remote from the frame 3. The second massage member may be rotatable, for example, about an axis of rotation Z that may be perpendicular to the longitudinal axis X, for example.

The invention is not limited to the exemplary embodiments described above.

For example, the handle 2 may include a reservoir containing a composition to be applied.

The device 1 may be provided with a vibrator.

The expression “comprising a” should be understood as being synonymous with “comprising at least one” unless specified to the contrary.

Although various details of the present invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

What is claimed is:

1. A massage device comprising:
an elongate handle comprising a handle-forming body, and a frame including an orientation that is substantially constant relative to the body; and
an elastically deformable first massage member that defines a massage surface configured to come into contact with a region to be treated, and a side opposite from the massage surface, the massage member including a periphery at which the massage member is secured to the frame, and being configured to be deformed by a user by exerting pressure on the massage member on the side opposite from the massage surface, the massage surface being outwardly convex and solid.

2. A device according to claim 1, wherein the frame includes a closed outline.

3. A device according to claim 2, wherein the frame includes a circular shape.

4. A device according to claim 1, wherein the frame extends along a plane that forms an angle relative to a longitudinal axis of the body of the handle that is strictly less than 90°.

5. A device according to claim 4, wherein the angle lies in a range of about 1° to about 80°.

6. A device according to claim 1, wherein the massage member comprises a membrane.

7. A device according to claim 6, wherein the membrane is elastic.

8. A device according to claim 7, wherein the membrane comprises an elastomer.

9. A device according to claim 6, wherein the membrane includes a structure fitted to the massage-surface side.

10. A device according to claim 9, wherein the fitted structure comprises at least one of a net, a foam, a textile, and a non-woven fabric.

11. A device according to claim 1, wherein, at rest, the massage surface includes a shape that projects beyond the frame.

12. A device according to claim 1, wherein the massage member includes undulations.

13. A device according to claim 1, wherein the massage member comprises portions in relief.

14. A device according to claim 13, wherein the portions in relief are distributed evenly over the massage surface.

15. A device according to claim 13, wherein the portions in relief are distributed unevenly over the massage surface.

16. A device according to claim 1, wherein the massage member is molded over the handle, and secured to the handle thereby.

17. A device according to claim 1, wherein the massage member is fastened to the handle in an interchangeable manner.

18. A device according to claim 17, wherein the massage member is at least one of snap-fastened and screw-fastened to the handle.

19. A device according to claim 1, wherein the massage member is at least one of bonded and heat-sealed on the handle.

20. A device according to claim 1, wherein the massage member comprises a finger on the side opposite from the massage surface, the finger being configured to enable the user to deform the massage surface.

21. A device according to claim 1, further comprising an intermediate part on the side opposite from the massage surface, the intermediate part being configured to enable the user to deform the massage member by pressing against the intermediate part.

22. A device according to claim 1, wherein the massage member comprises at least one of a net, a mesh, and a foam.

23. A device according to claim 1, wherein the massage member comprises spikes.

24. A device according to claim 1, further comprising a second massage member at a different end of the handle than the first massage member.

25. A device according to claim 24, wherein the second massage member is rotatable.

26. A massage method using a massage member of a massage device as defined in claim 1, comprising applying the message member to at least one of a region of a living body and a face.

27. A method according to claim 26, further comprising pressing at least one finger against the massage member on the side opposite from the massage surface.
